(19) United States
(12) Patent Application Publication
(10) Pub. No.: US 2025/0276707 A1
(43) Pub. Date: Sep. 4, 2025

(54) SYSTEM SAFETY ASSOCIATED WITH VEHICLE AUTONOMY

(71) Applicant: Rivian IP Holdings, LLC, Irvine, CA (US)

(72) Inventor: Vasant Kumar EASWARAN, Frisco, TX (US)

(21) Appl. No.: 19/053,214

(22) Filed: Feb. 13, 2025

Related U.S. Application Data
(60) Provisional application No. 63/560,591, filed on Mar. 1, 2024.

(51) Int. Cl. B60W 50/029; B60W 50/02; B60W 60/00

(52) U.S. Cl. CPC B60W 50/029; B60W 50/0205; B60W 60/00186; B60W 2050/0295; B60W 2510/244; B60W 2510/246

(57) ABSTRACT

Methods, systems, and apparatuses, among other things, as described herein may provide for using intelligent power supplies or redundant SOCs to meet safety integrity or availability for Level 2 or Level 3 autonomy systems.

### CROSS REFERENCE TO RELATED APPLICATION(S)

The present application claims the benefit of U.S. Provisional Application No. 63/560,591 entitled, “SYSTEM SAFETY FOR LEVEL 2 OR LEVEL 3 AUTONOMY”, filed Mar. 1, 2024, the entirety of which is incorporated herein for reference.

### INTRODUCTION

Automotive Safety Integrity Level (ASIL) is a risk classification system defined by the ISO 26262 standard for the functional safety of road vehicles. ASIL classifies hazards in one of four levels, denoted as A through D, with a fifth additional level for non-hazardous systems or components. ASIL D represents the highest level of risk, while ASIL A represents the lowest risk level.

The standard defines functional safety as “the absence of unreasonable risk due to hazards caused by malfunctioning behavior of electrical or electronic systems.” ASILs establish safety requirements—based on the probability and acceptability of harm—for automotive components to be compliant with ISO 26262.

Systems that include vehicle brakes may require an ASIL-D grade—the highest rigor applied to safety assurance—because of the significant risks associated with their failure. ASIL-B examples are headlights and brake lights, while ASIL C may be for systems that include cruise control. Rear lights are example lights that may be classified with an ASIL-A grade.

Aspects of the subject technology can help to improve the overall cost, reliability, and efficiency of circuits or other electronic components.

### SUMMARY

The present description is generally directed to intelligent power supplies or redundant SOCs that may be implemented to meet safety integrity and availability for Level 2 or Level 3 autonomy systems.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an exemplary integrated circuit associated with safety or availability of Level 2 autonomy vehicles.

FIG. 2 illustrates an exemplary sequence diagram associated with a safety island monitoring a system-on-a-chip (SOC) in a Level 2 autonomy system.

FIG. 3 illustrates an exemplary sequence diagram associated with safety ASIL-D power management integrated circuit (PMIC) monitoring ASIL-D safety island and notifying the vehicle system in a Level 2 autonomy system.

FIG. 4 illustrates an exemplary integrated circuit associated with safety or availability of Level 3 autonomy vehicles.

FIG. 5 illustrates an exemplary sequence diagram associated with a seconds SOC and first safety island monitoring a first SOC in a Level 3 autonomy system.

FIG. 6 illustrates an exemplary sequence diagram associated with a second SOC and first safety ASIL-D PMIC monitoring a first ASIL-D safety island of a first SOC in a Level 3 autonomy system.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

There are six levels of driving automation ranging from 0 (fully manual) to 5 (fully autonomous) that have been adopted by the U.S. Department of Transportation. In an example, with regard to Level 2 autonomy, there are advanced driver assistance systems (ADAS) that may provide continuous assistance with acceleration, braking, and steering, while a driver sits in the driver seat of a vehicle and can take control of the vehicle at any time. The driver remains engaged and attentive. ASIL-rated SoCs may be used to implement such automated driving.

Vehicles executing Level 3 autonomy may have environmental detection capabilities and can make informed decisions for themselves, such as accelerating past a slow-moving vehicle. The Level 3 system actively performs driving tasks while a driver remains available to take over. If the system can no longer operate and prompts the driver, the driver should be available to resume driving tasks.

ASIL rated SoCs typically have several safety critical use cases which are required to meet differing levels of safety integrity. Due to the differing coverage and residual failure rates of different ASIL levels, care is taken that the requirements are met with mitigations planned for any interference between the ASIL domains. To address monitoring needs of vehicle systems (e.g., one or more electronic components), the safety goals may be realized via various levels of ASIL decomposition. While doing these decompositions, there may be safe isolations planned at the intersection of boundaries for electrical, data, or control paths of vehicle systems that may allow for safe detection of faults (e.g., errors) of electronic components.

The isolation capability may ensure availability of higher integrity functions in the event of faults detected in lower integrity functions. In implementing this isolation capability, the availability requirements in Level 2 autonomy systems may be addressed opportunistically since the fail-over is back to a driver in such systems. As discussed in more detail herein, intelligent power supplies—instead of high integrity micro controllers—may be implemented to meet safety integrity and availability for Level 2 autonomy systems at a possibly lower cost point.

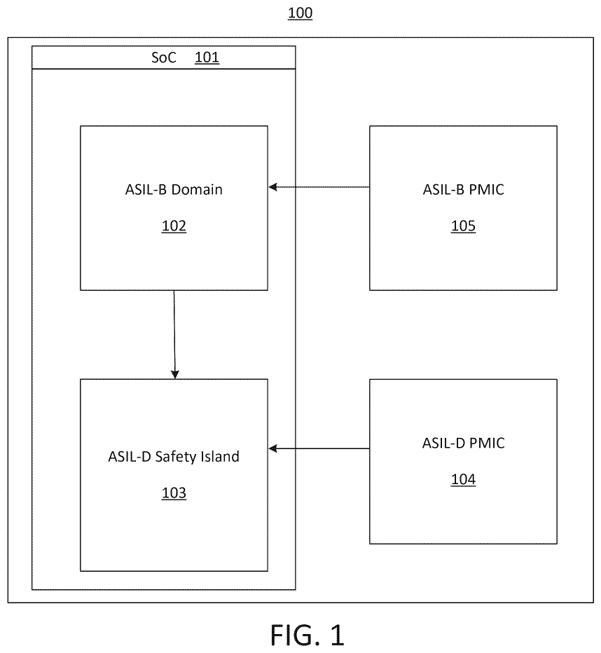

FIG. 1 illustrates an exemplary integrated circuit associated with safety or availability of Level 2 autonomy vehicles. With regard to Level 2 autonomy, system 100 may include system-on-a-chip (SOC) 101. SOC 101 may include ASIL-B domain 102 (e.g., a power domain) or ASIL-D safety island 103. ASIL-B domain 102 may include safety mechanisms that achieve ASIL-B integrity across safety critical use cases that use different subsystems in this ASIL-B domain 102. ASIL-B domain 102 may be communicatively connected with one or monitor ASIL-B power management integrated circuit (PMIC) 105, ASIL-D safety island 103, or ASIL-D PMIC 104. ASIL-B PMIC 105 may include safety mechanisms that achieve ASIL-B integrity across safety critical voltage rails powering the ASIL-B SoC domain (e.g., ASIL-B domain 102).

With continued reference to FIG. 1, ASIL-D safety island 103 may include processors with hardware features, such as error correction code (ECC) and a programmable watchdog timer to detect system failures or runtime faults. The processors may include a lockstep interface that is used by the integrated safety monitor to compare outputs and detect if a fault has occurred. ASIL-D safety island 103 may include safety mechanisms that achieve ASIL-D integrity across safety critical use cases that use different subsystems in this domain. In addition, safety mechanisms of ASIL-D safety island 103 may monitor ASIL-B domains (e.g., ASIL-B domain 102) to achieve higher levels of integrity through ASIL decomposition.

ASIL-D PMIC 104 may include safety mechanisms that achieve ASIL-D integrity across safety critical voltage rails powering ASIL-D safety island 103. In addition, safety mechanisms of ASIL-D PMIC 104 may monitor ASIL-D safety island 103 to achieve higher levels of integrity by mitigating risk of dependent failures within SOC 101. Instead of using a microcontroller (MCU), ASIL-D PMIC 104 may be used to monitor SOC 101, as shown in FIG. 1. SOC 101 may include ASIL-D safety island 103 and ASIL-B domain 102. The minimal functions that may be provided by the MCU may be implemented by ASIL-D PMIC 104. The use of ASIL-D PMIC 104 as disclosed is sufficient for the required safety integrity. ASIL-D PMIC 104 may not only include monitoring capability for power rails, but other monitoring capabilities, such as a watchdog timer. In an example, SOC 101, through its communications interfaces within the integrated circuit may write to certain registers in the watchdog timer at a certain frequency (e.g., 50 ms periodically). When the frequency of writing to the register is maintained, the watchdog timer may reset its counter every time. When the frequency of writing to the register is not maintained, an alert may be indicated and ASIL-D PMIC 104 (since it controls power management) may shut off the power rails to the SOC 101, which may take the vehicle system to a safe state. And through the communication interfaces of ASIL-D PMIC 104, higher level systems may be alerted of the fault, which may eventually be displayed (e.g., display a message that level 2 autonomy has failed).

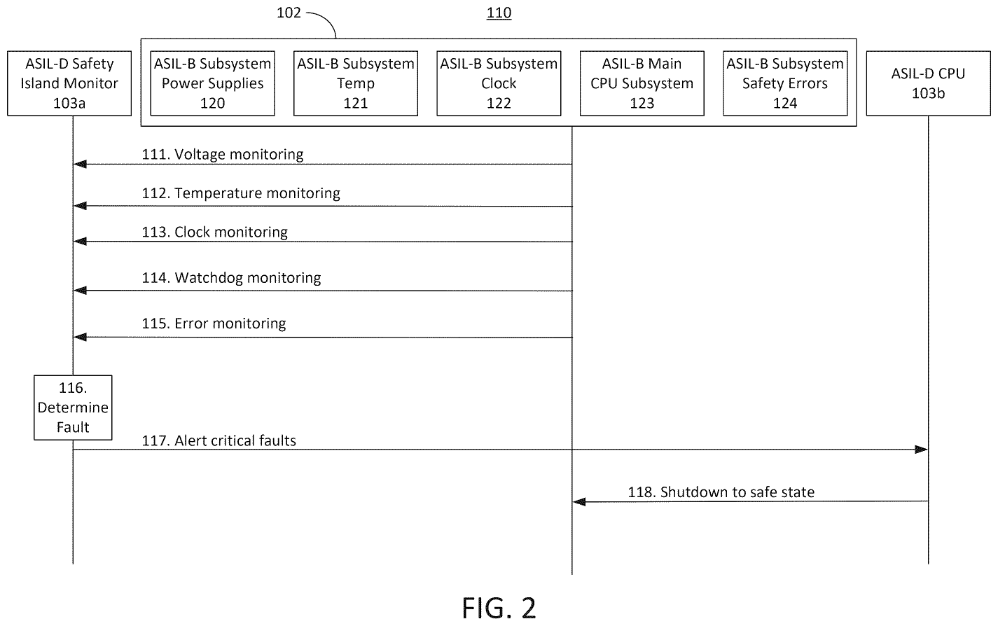

FIG. 2 illustrates an exemplary sequence diagram of system 110 associated with safety island 103 monitoring SOC 101. At step 111 through step 115, ASIL-D safety island monitor 103a may monitor the state of one or more ASIL-B subsystems. ASIL-B subsystems of ASIL-B domain 102 may include one or more ASIL-B subsystems 120 for power supplies (e.g., associated with step 111), ASIL-B subsystems 121 for temperatures (e.g., associated with step 112), ASIL-B subsystems 122 for clock (e.g., associated with step 113), ASIL-B subsystems 123 for main CPU (e.g., associated with step 114), or ASIL-B subsystems 124 for safety errors (e.g., associated with step 115), among others.

The monitoring may be based on receiving information within a designated threshold or not receiving information within a designated period. At step 116, based on the monitoring of step 111-step 115, a fault may be determined. At step 117, for example, an alert associated with a critical fault may be sent to ASIL-D CPU 103b. At step 118, based on receiving the alert, ASIL-D CPU 103b may send indication to one or more ASIL-B subsystems of ASIL-B domain 102, to shutdown, which may place a vehicle system into a safe state. It is contemplated herein that ASIL-D safety island 103 may include ASIL-D safety island monitor 103a or ASIL-D CPU 103b.

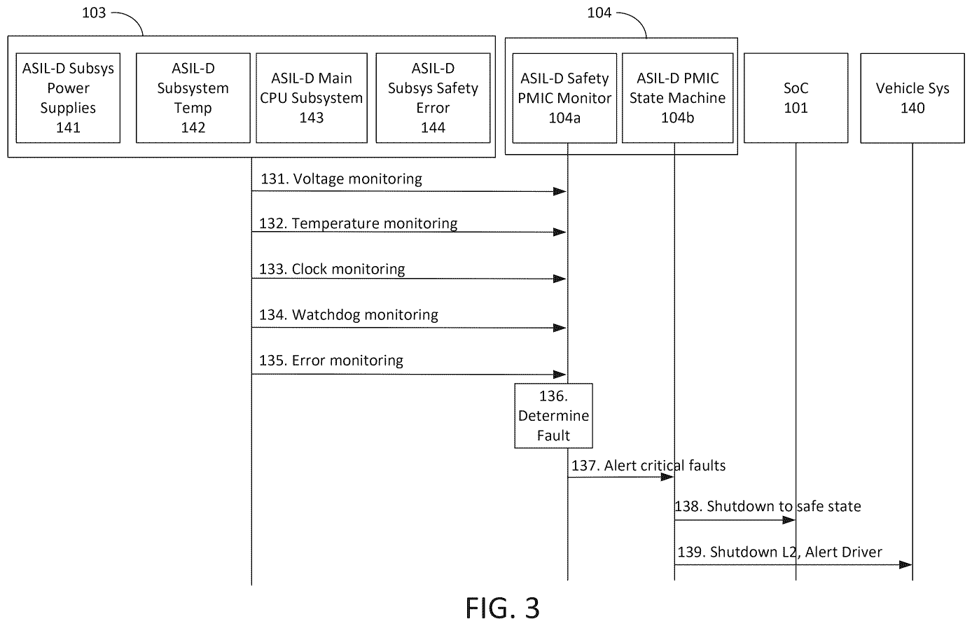

FIG. 3 illustrates an exemplary sequence diagram associated with safety ASIL-D PMIC 104 monitoring ASIL-D safety island 103 and notifying the vehicle system 140. At step 131 through step 135, ASIL-D PMIC 104 (e.g., ASIL-D safety PMIC monitor 104a) may monitor the state of one or more ASIL-D safety island 103 subsystems. ASIL-D safety island 103 subsystems may include one or more ASIL-D subsystems 141 for power supplies (e.g., associated with step 131), ASIL-D subsystems 142 for temperatures (e.g., associated with step 132), ASIL-D subsystems 143 for main CPU (e.g., associated with step 134), or ASIL-D subsystems 144 for safety errors (e.g., associated with step 135), among others (e.g., step 133).

The monitoring may be based on receiving information within a designated threshold or not receiving information within a designated period. At step 136, based on the monitoring of step 131-step 135, a fault may be determined. At step 137, for example, an alert associated with a critical fault may be sent to ASIL-D PMIC state machine 104b. At step 138, based on receiving the alert, ASIL-D PMIC state machine 104b may send an indication to one or more components of SOC 101, to shutdown, which may place a vehicle system into a safe state. At step 139, ASIL-D PMIC state machine 104b may shutdown Level 2 autonomy and send an alert for the driver. It is contemplated that the components of processing flow of FIG. 2 or FIG. 3 may be on a single component or may be functional components. Vehicle system 140 may include one or more components of FIG. 1.

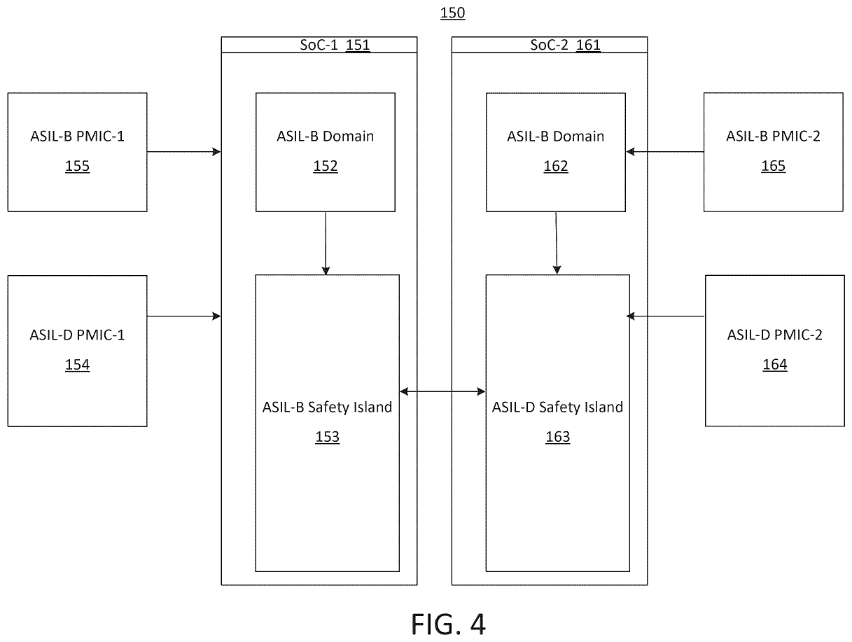

FIG. 4 illustrates an exemplary integrated circuit associated with safety or availability of automated vehicles. With regard to Level 3 autonomy, system 150 may include system-on-a-chip (SOC) 151. SOC 151 may include ASIL-B domain 152 (e.g., a power domain) or ASIL-D safety island 153. ASIL-B domain 152 may include safety mechanisms that achieve ASIL-B integrity across safety critical use cases that use different subsystems in this ASIL-B domain 152. ASIL-B domain 152 may be communicatively connected with one or monitor ASIL-B PMIC 155, ASIL-D safety island 153, or ASIL-D PMIC 154. ASIL-B PMIC 155 may include safety mechanisms that achieve ASIL-B integrity across safety critical voltage rails powering the ASIL-B SoC domain (e.g., ASIL-B domain 152). SOC 151 may be communicatively connected with SOC 161, which may be connected via ASIL-D safety island 153 with ASIL-D safety island 163.

With continued reference to FIG. 4, ASIL-D safety island 153 may include safety mechanisms that achieve ASIL-D integrity across safety critical use cases that use different subsystems in this domain. Safety mechanisms of ASIL-D safety island 153 may monitor ASIL-B domains (e.g., ASIL-B domain 102) to achieve higher levels of integrity through ASIL decomposition. In an event of an irrecoverable fault in this ASIL-D domain (e.g., ASIL-D safety island 153), an external ASIL-D domain (e.g., ASIL-D safety island 163) may monitor ASIL-D safety island 153 and initiate a degraded mode of operation in the event of a fault. Similarly, this ASIL-D domain (e.g., ASIL-D safety island 153) may also monitor an external ASIL-D domain (e.g., ASIL-D safety island 163) and initiate a degraded mode of operation in the event of a fault.

ASIL-D PMIC 154 may include safety mechanisms that achieve ASIL-D integrity across safety critical voltage rails powering ASIL-D safety island 153. In addition, safety mechanisms of ASIL-D PMIC 154 may monitor ASIL-D safety island 153 to achieve higher levels of integrity by mitigating risk of dependent failures within the SOC 151.

With continued reference to FIG. 4, system 150 may include system-on-a-chip (SOC) 161. SOC 101 may include ASIL-B domain 162 (e.g., a power domain) or ASIL-D safety island 163. ASIL-B domain 162 may include safety mechanisms that achieve ASIL-B integrity across safety critical use cases that use different subsystems in this ASIL-B domain 162. ASIL-B domain 162 may be communicatively connected with one or monitor ASIL-B PMIC 165, ASIL-D safety island 163, or ASIL-D PMIC 164. ASIL-B PMIC 165 may include safety mechanisms that achieve ASIL-B integrity across safety critical voltage rails powering the ASIL-B SoC domain (e.g., ASIL-B domain 162). SOC 161 may be communicatively connected with SOC 161, which may be connected via ASIL-D safety island 163 with ASIL-D safety island 153.

With continued reference to FIG. 4, ASIL-D safety island 163 may include safety mechanisms that achieve ASIL-D integrity across safety critical use cases that use different subsystems in this domain. Safety mechanisms of ASIL-D safety island 163 may monitor ASIL-B domains (e.g., ASIL-B domain 162) to achieve higher levels of integrity through ASIL decomposition. In an event of an irrecoverable fault in this ASIL-D domain (e.g., ASIL-D safety island 163), an external ASIL-D domain (e.g., ASIL-D safety island 153) may be monitoring this domain and initiate a degraded mode of operation in the event of a fault. Similarly, this ASIL-D domain (e.g., ASIL-D safety island 163) may also monitor an external ASIL-D domain (e.g., ASIL-D safety island 153) and initiate a degraded mode of operation in the event of a fault.

ASIL-D PMIC 164 may include safety mechanisms that achieve ASIL-D integrity across safety critical voltage rails powering ASIL-D safety island 163. In addition, safety mechanisms of ASIL-D PMIC 164 may monitor ASIL-D safety island 163 to achieve higher levels of integrity by mitigating risk of dependent failures within the SOC 161. As disclosed, when the two SOCs (SOC 151 and SOC 161) are communicating with each other, they can also monitor each other. Therefore, in an example, SOC 161 or ASIL-D PMIC 154 may monitor ASIL-D safety island 153 and SOC 151 or ASIL-D PMIC 164 may monitor ASIL-D safety island 163. This particularly may be implemented for level 3 autonomy. This configuration may reduce the number of hops needed for alerting SOC 161 (if SOC 151 is in a fault condition) and trigger SOC 161 to implement a degraded functionality. For example, instead of two hops (e.g., ASIL-D safety island 153 to ASIL-D PMIC 154 to SOC 161) there may be one hop (e.g., ASIL-D safety island 153 to SOC 161). Degraded functionality (also referred herein as degraded mode of operation) may include reducing from Level 3 to Level 2, performing automated driving at a designated speed for a period (e.g., 40 mph for 30 seconds, 75% or less of the posted speed limit of the road, or the like), submitting control to a driver, or stopping the vehicle.

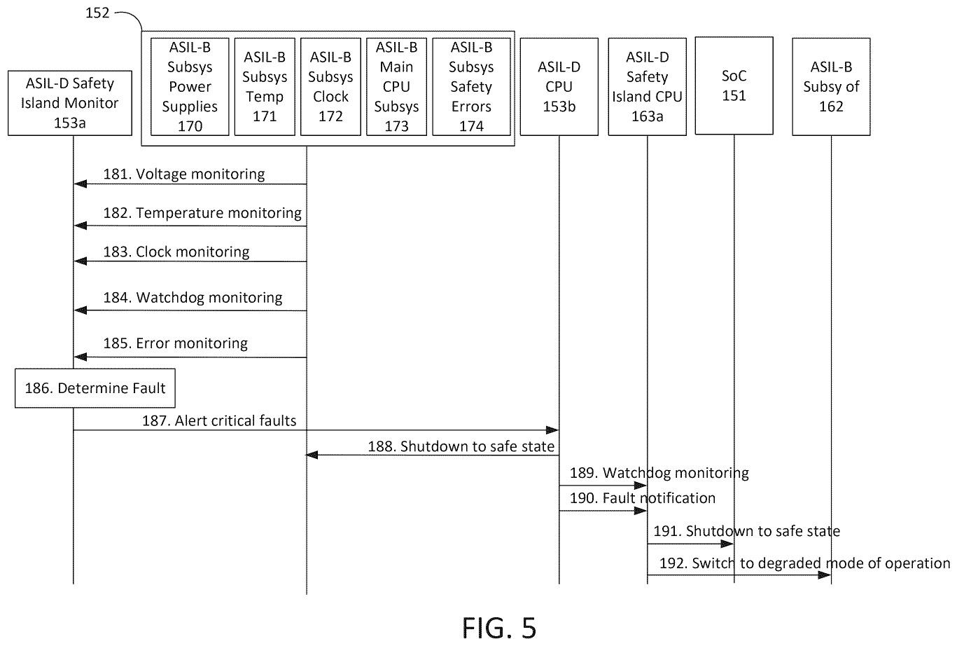

FIG. 5 illustrates an exemplary sequence diagram associated with SOC 161 and safety island 153 monitoring SOC 151. At step 181 through step 185, ASIL-D safety island monitor 153a may monitor the state of one or more ASIL-B subsystems of ASIL-B domain 152. ASIL-B subsystems of ASIL-B domain 152 may include one or more ASIL-B subsystems 170 for power supplies (e.g., associated with step 181), ASIL-B subsystems 171 for temperatures (e.g., associated with step 182), ASIL-B subsystems 172 for clock (e.g., associated with step 183), ASIL-B subsystems 173 for main CPU (e.g., associated with step 184), or ASIL-B subsystems 174 for safety errors (e.g., associated with step 185), among others.

The monitoring may be based on receiving information within a designated threshold or not receiving information within a designated period. At step 186, based on the monitoring of step 181-step 185, a fault may be determined. At step 187, for example, an alert associated with a critical fault may be sent to ASIL-D CPU 153b. At step 188, based on receiving the alert, ASIL-D CPU 153b may send an indication to one or more ASIL-B subsystems of ASIL-B domain 152, to shutdown, which may place a vehicle system into a safe state. At step 189, ASIL-D safety island CPU 163a may monitor ASIL-D CPU 153b (e.g., via watchdog timer monitor). At step 190, ASIL-D CPU 153b may send a fault notification (which may be based on alert of step 187) to ASIL-D safety island CPU 163a. The fault notification may be sent via error pins or serial peripheral (SPI) communication. At step 191, ASIL-D safety island CPU 163a may send, to SoC 151, an indication to shutdown to get into a safe state. At step 192, ASIL-D safety island CPU 163a may send an indication to ASIL-B subsystem of ASIL-B domain 162 to switch to a degraded mode of operation. It is contemplated herein that ASIL-D safety island 153 may include ASIL-D safety island monitor 153a or ASIL-D CPU 153b.

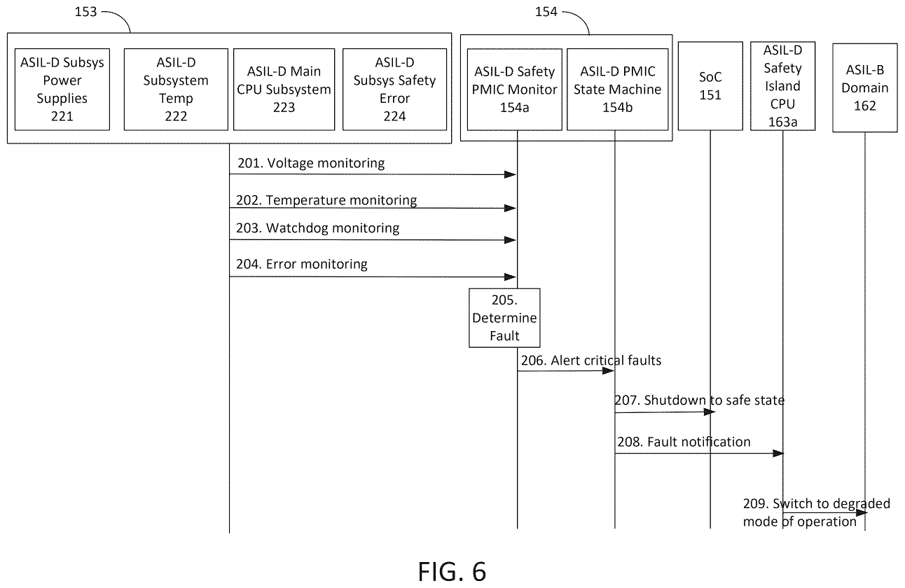

FIG. 6 illustrates an exemplary sequence diagram associated with SOC 161 and safety ASIL-D PMIC 154 monitoring ASIL-D safety island 153 of SOC 151. At step 201 through step 204, ASIL-D PMIC 154 (e.g., ASIL-D safety PMIC monitor 154a) may monitor the state of one or more ASIL-D safety island 153 subsystems. ASIL-D safety island 153 subsystems may include one or more ASIL-D subsystems 221 for power supplies (e.g., associated with step 201), ASIL-D subsystems 222 for temperatures (e.g., associated with step 202), ASIL-D subsystems 223 for main CPU (e.g., associated with step 203), or ASIL-D subsystems 224 for safety errors (e.g., associated with step 204), among others.

The monitoring may be based on receiving information within a designated threshold or not receiving information within a designated period. At step 205, based on the monitoring of step 201-step 204, a fault may be determined. At step 206, for example, an alert associated with a critical fault may be sent to ASIL-D PMIC state machine 154b. At step 207, based on receiving the alert, ASIL-D PMIC state machine 154b may send an indication to one or more components of SOC 151 to shut down to get into a safe state. At step 208, ASIL-D PMIC state machine 154b may send a fault notification, which may be via error pins, to one or more components of SOC 151. At step 209, ASIL-D Safety Island CPU 163a of SOC 161 may send to SOC 161 (e.g., ASIL-B domain 162 or ASIL-D safety island CPU 163a) an indication to switch to a degraded mode of operation (e.g., from Level 3 to Level 2 or driver takeover). It is contemplated that the components of processing flow of FIG. 5 or FIG. 6 may be on a single component or may be functional components. It is also contemplated that each SOC checks on each other, so the steps associated with FIG. 5 and FIG. 6 may be appropriately mirrored.

The disclosed subject matter herein associated with safety or availability of automated vehicles for Level 2 or Level 3 autonomy may be more frequently implemented in scenarios with vertical integration of a robust SOC 101, in which one entity may be responsible for the design of the majority of the system. For example, if the SOC 101 is designed as disclosed then ASIL-D PMIC 104 may be sufficient instead of or in addition to an MCU, which may save cost and meet the required integrity. There may be multiple ways to achieve different levels of ASIL.

The disclosed subject matter may be used in or with automotive electronic components. Electronic components may be integrated into automobiles, such as an electric vehicle. The disclosed subject matter may result in a reduced number of components, reduced complexity of a system, or more efficient communication between components. In an exemplary implementation, the system proceeds to a safe state, such as shutting down an autonomous system application, which would functionally be safe.

Methods, systems, and apparatuses, among other things, as described herein may provide for using intelligent power supplies or redundant SOCs to meet safety integrity or availability for Level 2 or Level 3 autonomy systems. All combinations of the steps disclosed herein (including the removal or addition of steps or components) are contemplated in a manner that is consistent with the other portions of the detailed description.

Systems and methods for monitoring safety in autonomous vehicles are disclosed herein. A system may provide for an ASIL-B domain; an ASIL-D safety island communicatively connected with the ASIL-B domain; and an ASIL-D power management integrated circuit (PMIC) communicatively connected with the ASIL-D safety island; wherein the ASIL-D PMIC monitors operation of the ASIL-D safety island and initiates a shutdown sequence upon detecting a fault condition. The system may further include an ASIL-B PMIC communicatively connected with the ASIL-B domain, wherein the ASIL-B PMIC comprises safety mechanisms achieving ASIL-B integrity across safety critical voltage rails powering the ASIL-B domain. All combinations (including the removal or addition of steps) in this paragraph and the above paragraphs are contemplated in a manner that is consistent with the other portions of the detailed description.

A method for level two or level three autonomy may include monitoring, by an automotive safety integrity level-D (ASIL-D) power management integrated circuit (PMIC), operation of a first ASIL-D safety island domain of a first SOC, wherein the SOC comprises the first ASIL-D safety island domain communicatively connected with one or more ASIL-B subsystems of an ASIL-B domain; determining, by the ASIL-D PMIC, a fault condition associated with the first ASIL-D safety island domain; and based on determining that there is the fault, transmitting an indication to enter into a degraded mode of operation. The method may include monitoring, by a second ASIL-D safety island domain of a second SOC, the first ASIL-D safety island domain of the first SOC. The monitoring operation of the first ASIL-D safety island comprises monitoring one or more of power supplies, temperatures, or watchdog timers of the first ASIL-D safety island. Based on the indication of the fault condition, an indication to shutdown one or more components of the first SOC to a safe state may be transmitted. The degraded mode of operation comprises reducing from level three autonomy to level two autonomy, wherein the one or more applications comprise an autonomous driving application. All combinations (including the removal or addition of steps) in this paragraph and the above paragraphs are contemplated in a manner that is consistent with the other portions of the detailed description.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, or systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A method for level two or level three autonomy, the method comprising:
monitoring, by an automotive safety integrity level-D (ASIL-D) power management integrated circuit (PMIC), operation of a first ASIL-D safety island domain of a first system on chip (SOC), wherein the first SOC comprises the first ASIL-D safety island domain communicatively connected with one or more ASIL-B subsystems of an ASIL-B domain;
determining, by the ASIL-D PMIC, a fault condition associated with the first ASIL-D safety island domain; and
based on determining that there is the fault condition, transmitting an indication to shutdown one or more components of the first SOC to a safe state.

2. The method of claim 1, further comprising monitoring, by a second ASIL-D safety island domain of a second SOC.

3. The method of claim 1, wherein the monitoring operation of the first ASIL-D safety island domain comprises monitoring one or more of power supplies of the first ASIL-D safety island domain.

4. The method of claim 1, wherein the monitoring operation of the first ASIL-D safety island domain comprises monitoring for one or more temperatures.

5. The method of claim 1, wherein the monitoring operation of the first ASIL-D safety island domain comprises monitoring one or more watchdog timers of the first ASIL-D safety island domain.

6. The method of claim 1, further comprising transmitting, based on the indication of the fault condition, an indication to cease operation of one or more applications or an indication to enter into a degraded mode of operation.

7. The method of claim 6, wherein the degraded mode of operation comprises reducing from level three autonomy to level two autonomy.

8. The method of claim 6, wherein the one or more applications comprise an autonomous driving application.

9. A system for monitoring safety in an autonomous vehicle, comprising:
an automotive safety integrity level-B (ASIL-B) domain;
an ASIL-D safety island domain communicatively connected with the ASIL-B domain; and
an ASIL-D power management integrated circuit (PMIC) communicatively connected with the ASIL-D safety island domain, wherein the ASIL-D PMIC monitors operation of the ASIL-D safety island domain and initiates a shutdown sequence upon detecting a fault condition.

10. The system of claim 9, further comprising:
an ASIL-B PMIC communicatively connected with the ASIL-B domain, wherein the ASIL-B PMIC comprises safety mechanisms achieving ASIL-B integrity across voltage rails powering the ASIL-B domain.

11. The system of claim 9, wherein the monitoring operation of the first ASIL-D safety island domain comprises monitoring one or more of power supplies of the first ASIL-D safety island domain.

12. The system of claim 9, wherein the monitoring operation of the first ASIL-D safety island domain comprises monitoring for one or more temperatures.

13. A method for level two or level three autonomy, the method comprising:
monitoring, by an automotive safety integrity level-D (ASIL-D) power management integrated circuit (PMIC), operation of a first ASIL-D safety island domain of a first system on chip (SOC), wherein the first SOC comprises the first ASIL-D safety island domain communicatively connected with one or more ASIL-B subsystems of an ASIL-B domain;
determining, by the ASIL-D PMIC, a fault condition associated with the first ASIL-D safety island domain; and
based on determining that there is the fault condition, transmitting an indication to enter into a degraded mode of operation.

14. The method of claim 13, further comprising monitoring, by a second ASIL-D safety island domain of a second SOC, the first ASIL-D safety island domain of the first SOC.

15. The method of claim 13, wherein the monitoring operation of the first ASIL-D safety island domain comprises monitoring one or more power supplies of the first ASIL-D safety island.

16. The method of claim 13, wherein the monitoring operation of the first ASIL-D safety island comprises monitoring for one or more temperatures.

17. The method of claim 13, wherein the monitoring operation of the first ASIL-D safety island comprises monitoring one or more watchdog timers of the first ASIL-D safety island.

18. The method of claim 13, further comprising transmitting, based on the indication of the fault condition, an indication to shutdown one or more components of the first SOC to a safe state.

19. The method of claim 18, wherein the degraded mode of operation comprises changing from level three autonomy to level two autonomy.

20. The method of claim 18, wherein the degraded mode of operation comprises shutdown of an autonomous driving application.
